(19) United States
(12) Patent Application Publication
(10) Pub. No.: US 2012/0223819 A1
(43) Pub. Date: Sep. 6, 2012

(54) Near Field Communication Event Attendee Tracking System

(75) Inventors: James E. Burgess, Charlotte, NC (US); John C. Rukavina, Charlotte, NC (US)

(73) Assignee: Bank of America Corporation, Charlotte, NC (US)

(21) Appl. No.: 13/040,317

(22) Filed: Mar. 4, 2011

(51) Int. Cl. H04Q 5/22

(52) U.S. Cl. 340/10.42

(57) ABSTRACT

Tracking an attendee at an event includes providing a near field communications (NFC) device associated with an event station to facilitate tracking an attendee. A processor associates an identification code with an NFC tag, where the identification code is associated with the attendee and the NFC tag communicates with one or more other NFC devices to track the attendee through the event.

### TECHNICAL FIELD OF THE INVENTION

This invention relates generally to tracking attendees at an event, and specifically to utilizing near field communication to track attendees at an event.

### BACKGROUND

Event sponsors often desire to collect information about an event. For example, an event may include various locations that provide information about a number of topics. It may be desirable for the event sponsor to determine who attended the event, and how the attendees spent their time at the event.

### SUMMARY OF THE DISCLOSURE

In accordance with the present invention, disadvantages and problems associated with tracking attendees at an event may be reduced or eliminated.

According to one embodiment of the present invention, tracking an attendee at an event includes providing a near field communications (NFC) device associated with an event station to facilitate tracking an attendee. A processor associates an identification code with an NFC tag, where the identification code is associated with the attendee and the NFC tag communicates with one or more other NFC devices to track the attendee through the event.

Certain embodiments of the invention may provide one or more technical advantages. A technical advantage of one embodiment includes using NFC to track attendees' interaction with event stations at an event. Events are often crowded environments that can create interference issues for attendee tracking systems. The short range of NFC reduces interference issues and provides for a reliable standard for system to track attendees in crowded environments. Another technical advantage of an embodiment is that an attendee can choose which event stations the attendee wants to have read the NFC tag associated with the attendee. In this embodiment, an event sponsor can determine that an attendee has affirmatively expressed interest in the stations that read the NFC tag associated with the attendee. Yet another technical advantage of an embodiment includes providing an efficient, low impact, and simple method for event sponsors to track attendees, and attendees to interact with event stations. NFC tags are lightweight, affixable to articles that an attendee can carry or wear, and simple for an attendee to operate with little instruction.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a system that tracks attendees at an event;

FIG. 2 illustrates a particular embodiment of a database that stores attendee information; and

FIG. 3 illustrates a flowchart for a registration station registering an attendee at an event.

### DETAILED DESCRIPTION OF THE DRAWINGS

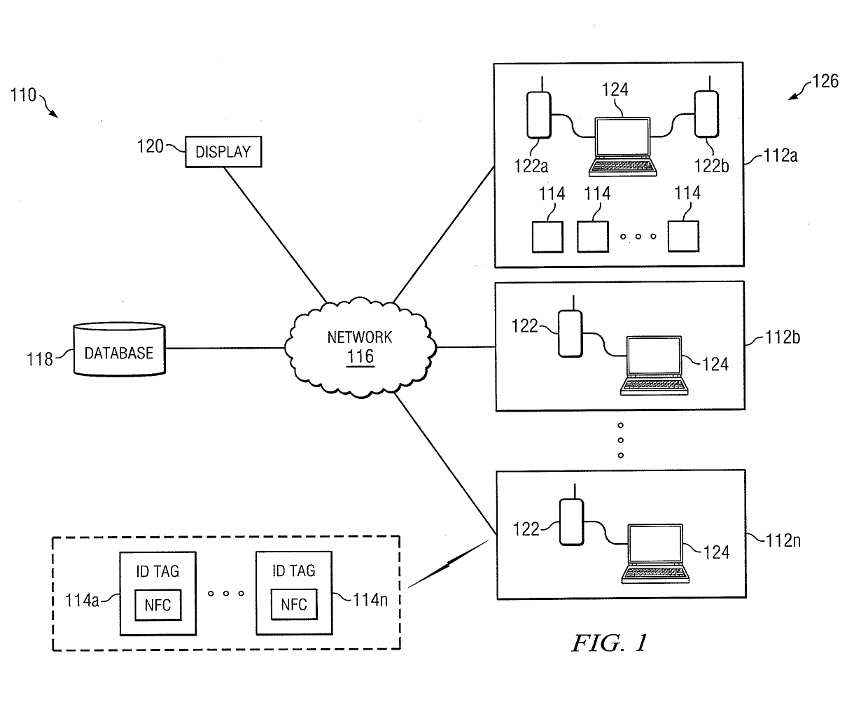

Embodiments of the present invention and its advantages are best understood by referring to FIGS. 1 through 3, like numerals being used for like and corresponding parts of the various drawings.

FIG. 1 illustrates a system 110 that tracks attendees at an event. System 110 includes any suitable number of NFC tags 114 that communicate with event stations 112. An event station 112 includes an NFC device 122, operable to read from, or write to, an NFC tag 114. Event station 112, database 118, and display 120 may communicate over network 116. Event station 112 may further include a computer 124 that communicates with database 118 and display 120 over network 116.

Event sponsors often desire to track attendees at an event. For example, an event may include event stations that provide information about a number of topics. It may be desirable for the event sponsor to determine who attended the event, and event stations 112 the attendee visited at the event. Tracking attendees at an event allows an event sponsor to acquire information about attendees, and to provide follow-up information targeted to the interests of attendees.

To facilitate tracking attendees at an event, system 110 utilizes near field communication (NFC). NFC is described in the International Standards Organization (ISO) 18092 network standard. NFC is useful for wireless communication at crowded events because NFC may be used in a short range, which minimizes interference problems present in other communication technologies. The short range may be less than twenty centimeters, less than ten centimeters, or other appropriate distance that complies with the standard. System 110 includes NFC tags 114a-114n, where n represents any suitable number. In an embodiment, NFC tags 114 may include an identification code pre-loaded onto the tag. In another embodiment, an identification code may be written onto NFC tag 114 at the event, for example, at registration station 126. System 110 may associate identification codes with an attendee, and an attendee may receive NFC tag 114 containing the identification code associated with the attendee. NFC tags 114 may affix to any article for an attendee to carry or wear, for example, a name tag, an identification card, a lanyard, or any other suitable article. NFC device 122 may read NFC tag 114 at a short range, for example, less than 20 cm. In an embodiment, NFC device 122 reads NFC tag 114 at approximately 1-3 cm. NFC tag 114 communicates with components of event station 112. In an embodiment, NFC tag 114 communicates with event station 112 through mobile phone 122. NFC tag 114 may communicate actively, by generating its own radio field, or passively, by modulating an existing radio field.

Event stations 112a-112n, where n represents any number of event stations at the event, represent any suitable location at an event where an attendee receives information related to the event or where the attendee provides information. Event station 112 may include a booth, a table, a kiosk, a person, or other suitable instrument for delivering or receiving information at an event. Event station 112 may be staffed by a person or may be automated. In an embodiment, event station 112 may be designated a registration station 126 where attendees register for the event.

In an embodiment, registration station 126 can take information from an attendee, such as name, contact information, background information (e.g., occupation, affiliations, etc.), or any additional information an event sponsor may want to obtain from an attendee. In one embodiment, registration station 126 may associate an identification code with the attendee and write the identification code onto NFC tag 114 using writing NFC device 122b. Alternatively, NFC tag 114 may be pre-loaded with an identification code that system 110 may associate with the attendee. Registration station 126 may also check attendees out of the event as they leave. Registration station 126 may perform check-out procedures, such as recovering an attendee's NFC tag 114, recording an attendee's departure time, gathering information about the attendee's experience at the event, and providing supplemental information of interest to the attendee. Registration station 126 may determine supplemental information for an attendee based on information gathered from tracking the attendee using system 110. Registration station 126 may store information about attendees, such as attendee identification number, name, contact information, background information, arrival time, check out time, and any additional information, on database 118. Registration station 126 may communicate with database 118 using computer 124.

Event station 112 includes an NFC device 122 operable to read information from, or write information to, an NFC tag 114. One NFC device 122 may perform both read and write functions, or event station 112 may have a reading NFC device 122a and/or a writing NFC device 122b. NFC device 122 may include a personal computer, a workstation, a laptop, a wireless or cellular telephone, an electronic notebook, a personal digital assistant, or any other device utilizing a processor (wireless, wireline, or otherwise) capable of receiving, processing, storing, and/or communicating information utilizing NFC. NFC device 122 may contain a station code that identifies station 112 associated with NFC device 122. NFC device 122 may store information, for example identification codes and station codes, locally on NFC device 122. NFC device 122 may also communicate with database 118 or display 120. NFC device 122 may utilize any suitable software environment to support NFC functionality, such as the Java 2 platform, Micro Edition (J2ME) application.

Event station 112 may further include a computer 124 that communicates with NFC device 122 to facilitate collecting and recording information about attendees. Computer 124 may communicate with NFC device 122 using any suitable communication protocol, such as Bluetooth®. Additionally, computer 124 may communicate with network 116, and may be able to access and interact with database 118 or display 120. Computer 124 communicates with database 118 to retrieve information or to store information. Information may include the attendee's name, contact information, background information, identification code, arrival time, or any other additional information an event sponsor may obtain from an attendee at registration station 126. Computer 124 may have access privileges to access or store information on database 118. For example, computer 124 may have administrative privileges and have full read/write abilities. As another example, computer 124 may have restricted privileges and can only read information from database 118. Computer 124 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 110. Computer 124 may also comprise a user interface, such as a display, a microphone, keypad, or other appropriate terminal equipment usable by a user.

Network 116 represents any suitable network operable to facilitate communication between the components of system 110 such as computers 124, NFC devices 122, NFC tags 114, database 118, and/or display 120. Network 116 may include any interconnecting system capable of transmitting audio, video, signals, data, messages, or any combination of the preceding. Network 116 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Database 118 represents a device that stores information about attendees, event stations 112, the event generally, and/or other suitable information. Database 118 includes any one or a combination of volatile or non-volatile local or remote devices suitable for storing information. For example, database 118 may include random access memory (RAM), read only memory (ROM), magnetic storage devices, optical storage devices, or any other suitable information storage device or combination of these devices.

Display 120 represents any suitable component that displays information to attendees, event sponsors, or other individuals at the event. Event stations 112 facilitate the display of information on display 120. The displayed information may include attendee's name, picture, identification information, location information, event station 112 information, event information, advertisements, or other relevant information. Display 120 represents any device that can electronically receive information and present it in a visually interpretable manner. Display 120 may be a type of monitor, screen, projector, tablet, television, or any other equivalent device.

A component of system 110, for example, event stations 112, registration stations 126, computers 124, NFC devices 122, NFC tags 114, networks 116, databases 118, or displays 120 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

In an exemplary embodiment of operation, an attendee arrives at an event and registers for the event at registration station 126. The attendee may provide information, such as name, contact information, background information (e.g. occupation, affiliations, etc), or any additional information an event sponsor may want to obtain from an attendee, at registration station 126. Registration station 126 may associate an identification code with the attendee and write the identification code onto an NFC tag 114, or alternatively, an NFC tag 114 may be pre-loaded with an identification code that the registration station 126 may associate with the attendee. The attendee receives NFC tag 114 containing an identification code associated with the attendee. NFC tag 114 may affix to an article that the attendee can carry or wear throughout the event, such as a name tag, identification card, lanyard, or other suitable article.

Upon receiving attendee information, registration station 126 communicates with database 118, using computer 124, to store information obtained from attendees in database 118. Information may include the attendee's name, contact information, background information, identification code, arrival time, or any other additional information an event sponsor may obtain from an attendee at a registration station 126. Registration station 126 may also communicate certain attendee information to display 120 for display at the event. For example, identification information such as an attendee's name, picture, or other indicia identifying the attendee, location information, or other relevant information may be displayed after the attendee has registered. Displaying the information alerts other attendees to an attendee's arrival, and provides identification information, location information, and/or other relevant information about the attendee to other attendees.

While at the event, an attendee may encounter event station 112. As the attendee encounters event station 112, the attendee may present NFC tag 114 to NFC device 122 at event station 112 and NFC device 122 reads the identification code associated with the attendee from NFC tag 114. Alternatively, NFC device 122 may automatically read the attendee's NFC tag 114 when the attendee is within a certain distance of event station 112. An event administrator may predefine this distance and may change this distance as necessary. NFC device 122 may communicate the attendee's identification code to computer 124 associated with event station 112. NFC device 122 may also communicate to computer 112 the station code of NFC device 122 associated with event station 112. Computer 124 may store information regarding the attendee's visit to station 112, such as identification code, station code, arrival time, departure time, or additional information, in database 118.

This process may repeat as an attendee navigates the event, and allows an event sponsor to track an attendee at an event. An event sponsor may obtain additional information from attendees at different stations 112, and an event sponsor may provide an attendee with additional information targeted to the attendee's interests. Additionally, an event sponsor may improve future events based on information collected from tracking attendees using system 110.

Modifications, additions, or omissions may be made to system 110 without departing from the scope of the invention. System 110 may include any number of event stations 112, registration stations 126, computers 124, NFC devices 122, NFC tags 114, networks 116, databases 118, or displays 120. System 110 may further utilize other short range communication standards, e.g., radio frequency identification (RFID). Any suitable logic may perform the functions of system 110 and the components within system 110.

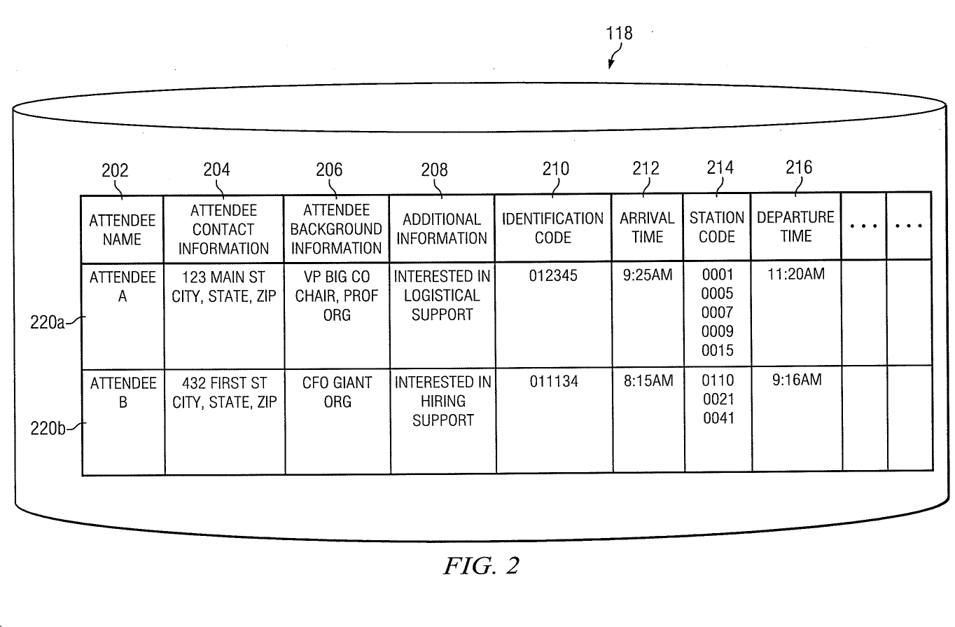

FIG. 2 illustrates a particular embodiment of a database 118 that stores attendee information. In an embodiment, database 118 stores attendee information before an event. For example, attendees pre-register for the event and database 118 stores the registration information before the event. Additionally, database 118 may store attendee information gathered from components of system 110 during the event. System 110 may store information in database 118 in an organized manner. In an embodiment, database 118 is organized by records 220 that contain information in particular fields.

In certain embodiments, database 118 may include one or more of the following fields: attendee name field 202, attendee contact information field 204, attendee background information field 206, additional information field 208, attendee identification code field 210, attendee arrival time field 212, station identification code field 214, attendee departure time field 216, and any other fields related to information about an attendee, an event, or an event sponsor. System 110 may sort the records database 118 by attendee, subsets of attendees, stations 112, or by another organizational format.

Attendee name field 202 represents an attendee's or prospective attendee's name. The name may be first, last, middle, a nickname, a combination of names, and may be in any order. Contact information field 204 represents contact information for an attendee or prospective attendee. The contact information may include home address, business address, phone numbers, email addresses, etc. Attendee background information field 206 represents attendee or prospective attendee background information. Background information field 206 may include occupation, employer, organizational affiliations, age, gender, interests, or any other information related to an attendee that is pertinent to an event or an event sponsor. Additional information field 208 represents information that an event sponsor may predefine and may want to obtain about an attendee.

Identification code field 210 represents a code that identifies the attendee and system 110 associates with an attendee. The information in identification code field 210 may be stored on NFC tag 114. Station code field 214 represents a code that identifies a particular station 112 at an event. Attendee arrival time field 212 represents a time when system 110 records an attendee's arrival at an event. Registration station 126 may record the arrival time when an attendee registers at an event. In another embodiment, arrival time field 212 may record whether an attendee has arrived at an event, but does not store a particular arrival time. Attendee departure time field 216 represents a time when an attendee departs from an event. Registration station 126 may record the departure time when an attendee checks out from an event. In another embodiment, departure time field 216 may record whether an attendee has departed from an event, but does not store a time.

Records 220 represent data structures that include information in various fields. In the illustrated embodiment, database 118 includes records 220a and 220b. In the illustrated embodiment, registration station 126 stores information in attendee name field 202, attendee contact information field 204, attendee background information field 206, additional information field 208, identification code field 210, and arrival time field 212 of records 220a and 220b when Attendee A and Attendee B register at the event. For example, record 220a includes Attendee A in attendee name field 202, the address in attendee contact information field 204, and the attendee's job title in attendee background information field 206. As Attendee A and Attendee B navigate the event, NFC devices 122 at stations 112 read the identification codes associated with Attendee A and Attendee B from their respective NFC tags 114, communicate the identification codes and the NFC device 122 station codes to computers 124, which store the information in the appropriate fields of database 118. Record 220a indicates that Attendee A is interested in logistical support and computer 124 stores that information in additional information field 208. For example, record 220a indicates that Attendee A visited stations 0001, 0005, 0007, 0009, and 0015. This information is stored in station code field 214. One or more stations 112 gather additional information about Attendee A and Attendee B, and use computers 124 to store the additional information in the additional information field 208 of database 118. Record 220a also indicates that Attendee A arrives at the event at 9:25 AM and associates Attendee A with identification code 012345, which system 110 stores in identification code field 210. Registration station 126 check out Attendee A and Attendee B when they each left the event and used computer 126 to store the departure times in the departure time field 216 of database 118.

System 110 may grant devices coupled to database 118, such as computer 124 or NFC device 122, specific access privileges. In an embodiment, system 110 may grant a device the privilege to read from and/or write to all of the fields of database 118, or a subset of fields of database 118. Device access privileges to database 118 may be based on station 112 associated with the particular device. For example, NFC device 122 and/or computer 124 associated with registration station 126 may have access privileges to each field in database 118 because it is the central station at the event, whereas another event station 112 may have access to a subset of the fields. In another embodiment, certain individuals may have access privileges to database 118 while other individuals do not. For example, an event sponsor may have administrative access privileges that allows the event sponsor to complete access to all fields on database 118 and read/write privileges, whereas a person staffing event station 112 may have limited access privileges.

Modifications, additions, or omissions may be made to database 118 without departing from the scope of the invention. For example, database 118 may comprise a number of databases. Database 118 may further include any number of records 220 or fields. Any suitable logic may perform the functions of database 118.

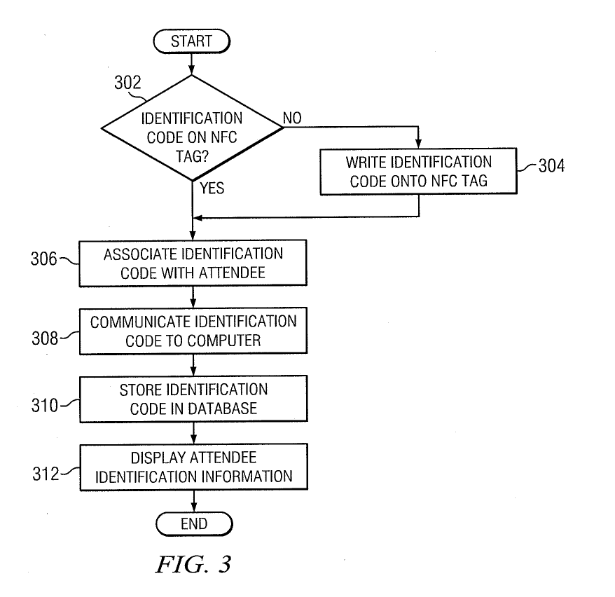

FIG. 3 illustrates a flowchart for registration station 126 registering an attendee at an event. The method begins at step 302 when an attendee registers for an event at registration station 126. NFC device 122 at registration station 126 reads NFC tag 114 to identify an identification code stored on NFC tag 114. The identification code may be written on NFC tag 114 at registration station 126, or the identification code may be pre-written onto NFC tag 114.

At step 306, system 110 associates the identification code with the registering attendee. In another embodiment, the identification code may already be associated with the attendee. Associating the identification code in NFC tag 114 with the attendee allows system 110 to track the attendee's interaction with stations 112 at the event. At step 308, NFC device 122 communicates the identification code read from NFC tag 114 to computer 124 associated with registration station 126. NFC device 122 may also communicate a station code that identifies registration station 126 associated with NFC device 122. In another embodiment, NFC device 122 may communicate an identification code and/or a station code to database 118 over network 116. At step 310, computer 124 communicates the station code associated with NFC device 122 and the identification code read from NFC tag 114 to database 118. Computer 124 may have a station code, or NFC device 122 may communicate a station code to computer 124. At step 312, computer 124 may facilitate the display of identification information about an attendee on display 120. The identification information may include name, photograph, or other information about the attendee. Computer 124 may receive this information from the attendee, a peripheral device such as a camera, database 118, or any other source. The illustrated method ends after step 312.

Modifications, additions, or omissions may be made to the flowchart without departing from the scope of the invention. For example, NFC device 122 may have the requisite capability to communicate directly with database 118, bypassing step 308. Any suitable logic may perform the functions of the flowchart.

Certain embodiments of the invention may provide one or more technical advantages. A technical advantage of one embodiment includes using NFC to track attendees' interaction with event stations 112 at an event. Events are often crowded environments that can create interference issues for attendee tracking systems. The short range of NFC reduces interference issues and provides for a reliable standard for system 110 to track attendees in crowded environments. Another technical advantage of an embodiment is that an attendee can choose which event stations 112 the attendee wants to have read the NFC tag associated with the attendee. In this embodiment, an event sponsor can determine that an attendee has affirmatively expressed interest in the stations 112 that read the NFC tag associated with the attendee. Yet another technical advantage of an embodiment includes providing an efficient, low impact, and simple method for event sponsors to track attendees, and attendees to interact with event stations 112. NFC tags 114 are lightweight, affixable to articles that an attendee can carry or wear, and simple for an attendee to operate with little instruction.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for tracking an attendee at an event, comprising:
a near field communications (NFC) device associated with an event station to facilitate tracking an attendee; and
an NFC tag associated with an identification code, wherein the identification code is associated with the attendee and the NFC tag communicates with one or more other NFC devices to track the attendee throughout the event.

2. The system of claim 1, wherein the NFC device is further operable to determine the identification code of the NFC tag; and
further comprising a computer operable to receive the identification code from the NFC device to facilitate displaying identification information of the attendee at the event.

3. The system of claim 2, wherein communicating the identification code to the computer comprises communicating the identification code to the computer using Bluetooth.

4. The system of claim 2, wherein the NFC device is further operable to communicate a station code to the computer that indicates an event station at the event.

5. The system of claim 2, wherein the computer is further operable to:
receive identification information of the attendee to facilitate displaying location information of the attendee at the event.

6. The system of claim 1, wherein the NFC device is further operable to encode the NFC tag with the identification code.

7. The system of claim 2, wherein the NFC device is further operable to communicate identification information to the database.

8. The system of claim 2, wherein the identification information includes the identification code.

9. A method for tracking an attendee at an event, comprising:
providing a near field communications (NFC) device associated with an event station to facilitate tracking an attendee; and
associating, using a processor, an identification code with an NFC tag, wherein the identification code is associated with the attendee and the NFC tag communicates with one or more other NFC devices to track the attendee throughout the event.

10. The method of claim 9, further comprising:
determining, using the processor, the identification code of the NFC tag; and
communicating the identification code to a computer to facilitate displaying identification information of the attendee at the event.

11. The method of claim 10, wherein communicating the identification code to the computer comprises communicating the identification code to the computer using Bluetooth.

12. The method of claim 10, further comprising determining, using the processor, a station code that indicates a location of the attendee at the event.

13. The method of claim 10, further comprising:
determining the identification information of the attendee; and
communicating the identification information of the attendee to the computer to facilitate displaying location information of the attendee at the event.

14. The method of claim 9, wherein associating an identification code with an NFC tag comprises encoding the NFC tag with the identification code.

15. A non-transitory computer readable medium comprising logic, the logic, when executed by a processor, operable to:
associate an NFC device with an event station to facilitate tracking an attendee;
associate an identification code with an NFC tag, wherein the identification code is associated with the attendee and the NFC tag communicates with one or more other NFC devices to track the attendee throughout the event.

16. The non-transitory computer readable medium of claim 15, further operable to:
determine, using the processor, the identification code of the NFC tag; and
communicate the identification code to a computer to facilitate displaying identification information of the attendee at the event.

17. The non-transitory computer readable medium of claim 16, further operable to communicate the identification code to the computer using Bluetooth.

18. The non-transitory computer readable medium of claim 16, further operable to determine, using the processor, a station code that indicates an event station at the event.

19. The non-transitory computer readable medium of claim 16, further operable to:
determine the identification information of the attendee; and
communicate the identification information of the attendee to the computer to facilitate displaying location information of the attendee at the event.

20. The non-transitory computer readable medium of claim 15, wherein associating an identification code with an NFC tag comprises encoding the NFC tag with the identification code.
